(19) United States
(12) Patent Application Publication
(10) Pub. No.: US 2022/0064905 A1
(43) Pub. Date: Mar. 3, 2022

(54) METHOD FOR TRACTION-RELATED CONTROL OF A DRIVELINE OF A WORKING MACHINE

(71) Applicant: ZF Friedrichshafen AG, Friedrichshafen (DE)

(72) Inventors: Gerhard BAILLY, Friedrichshafen (DE); Wolfgang STRAIF, Schärding (AT); Florian ELSNER, Fellbach (DE)

(21) Appl. No.: 17/459,127

(22) Filed: Aug. 27, 2021

(30) Foreign Application Priority Data
Sep. 2, 2020 (DE) 10 2020 211 075.1

(51) Int. Cl. E02F 9/22; E02F 9/20

(52) U.S. Cl. CPC E02F 9/2253; E02F 9/2062; E02F 9/2079

(57) ABSTRACT

A method for the traction-related control of a drive-train of a working machine (1) which has a drive unit (2), a transmission (3), a control unit (10) and first and second vehicle axles (7, 9) with rotatable wheels (6, 8). At least one of the vehicle axles (7, 9) is driven, and as a function of a specification either a first function (A) or a second function (B) is implemented. The first function (A) implements slip-orientated loading control and the second function (B) implements traction-efficiency control of the drive-train of the working machine (1).

This application claims priority from German patent application serial no. 10 2020 211 075.1 filed Sep. 2, 2020.

### FIELD OF THE INVENTION

The present invention relates to a method for the traction-related control of a drive-train of a working machine. In addition a working machine is included, which is operated with the method according to the invention. Working machines are mainly building machines or agricultural or forestry vehicles. In particular, agricultural or forestry vehicles are tractors or farming tractors. For various reasons the aim should be to obtain operating conditions of the working machine in which there is as little slip and/or as much traction at the driven wheels as possible.

### BACKGROUND OF THE INVENTION

From the prior art, methods for slip regulation are known. Such methods are described, for example, in WO 2009/141181 A1, DE 102 19 270 C1 and US 2016/0039480 A1. The methods known from the prior art are based on the specification of a constant upper limit for the slip during driving. The slip at the driven wheels is regulated in such manner that a specified limit value is not exceeded. The traction efficiency depends on the drive force applied at each wheel and the drive slip. If the traction conditions are good, then the maximum traction efficiency occurs with very little drive slip. However, if the traction conditions deteriorate, for example due to driving over a loose surface or the occurrence of an external load, the relationship between the traction efficiency and the drive slip changes. The maximum traction efficiency is then displaced in the direction toward higher slip values. If a constant upper limit is specified for the permissible drive slip, the vehicle cannot bring to bear its full drive torque under all ground conditions.

### SUMMARY OF THE INVENTION

The purpose of the present invention is to improve known methods for the traction-related control of a drive-train of a working machine, and in particular to provide a simplified method and thereby enable universal application with various vehicles.

That objective is achieved by the method according to the invention. In this, the working machine comprises a drive unit, a transmission and a control unit. The drive unit is for example in the form of an internal combustion engine or an electric machine that can be operated as a motor or as a motor and generator. The drive unit can also be a hybrid arrangement and correspondingly the drive-train will comprise, besides an internal combustion engine, also an electric machine that can be operated as a motor or as a motor and generator. In addition the working machine has at least a first and a second vehicle axle with wheels, wherein at least one vehicle axle is driven, i.e. functionally connected to the drive-train consisting of the drive unit and the transmission. In other embodiments the working machine can have more than two vehicle axles and more than one vehicle axle can be driven.

It is further provided that depending on a specification, either a first function or a second function for the traction-related control of the drive-train is implemented. The specification can then be given by an operator by way of a corresponding input device or by the control unit, for example coupled to a characteristic of the drive unit or other preferences. Such a specification can also be transmitted via an external interface, for example for remote maintenance or diagnosis. In that case the first function implements a slip-orientated load control of the drive-train, whereas the second function images a traction-efficiency control of the drive-train. The aim of the first function is to achieve an optimum or maximum loading of the drive-train with the least possible slip at the wheels. On the other hand, the focus of the second function is to maximize the power transmitted between the wheel and the roadway, i.e. to optimize a transmission efficiency between the wheel and the roadway. In other words, the second function represents a particularly economical operating mode in which the energy consumption of the drive unit is as low as possible. It is further provided that one can change between the two functions, whereby such an adaptation can take place even during the operation of the working machine.

If the first function is activated, there then takes place a determination of the current actual value of the slip at the wheels of the working machine. For this, with the help of a suitable measuring device an actual value of the driving speed of the working machine is determined. The measuring device can for example comprise a radar, lidar, GPS or optical sensor for image evaluation. This guarantees the determination of the actual driving speed over the ground. The actual value of the driving speed so determined is compared with an expected driving speed obtained from the wheel diameter and wheel rotational speed, or a drive output rotational speed of the transmission or a rotational speed of the drive unit, the gear ratio of the transmission engaged, a fixed axle gear ratio and the wheel diameter. Any difference between the two driving speed values is an indicator of the wheel slip.

The transmission can be in the form of an automated transmission, a powershift transmission, a dual-clutch transmission or a hydrostatic or hydrostatic/mechanical power-branched transmission. Furthermore, both the drive unit and the transmission can comprise a separate computation unit through which access to the controls of the drive unit and/or the transmission takes place. In particular, an adaptation of the rotational speed and torque of the drive unit or an adaptation of a gear ratio of the transmission can thereby be achieved. Alternatively, the computation units can also be combined in a vehicle control computer or in the control unit.

In addition, an actual value of the loading of the drive-train is determined. For this, for example, a ratio between the power output of the drive unit of the working machine in its current operating condition and the maximum available power of the drive unit is defined and used. Alternatively, an actual value of a traction force of the transmission relative to a maximum available traction force of the transmission in the current operating condition can be used. The loading of the drive-train depends on the drive output rotational speed of the transmission and the wheel slip.

Thereafter, it is determined whether the actual value of the drive-train loading is lower than a maximum loading value. If that is not the case, the drive output rotational speed of the transmission is reduced and the slip at the wheels is therefore also reduced. This can be done either by action upon the controls of the drive unit (rotational speed and/or torque modification) and/or by changing the transmission gear ratio. The result is to ensure that a maximum permissible loading of the components of the drive-train (transmission, vehicle axles, drive unit etc.) is not exceeded.

Besides an actual value of the drive-train loading, a target value of the drive-train loading is also taken into account. If the actual value of the loading is advantageously lower than the permissible maximum value at the same time as a difference (in particular a lower value) from the target value of the drive-train loading, then an increase of the wheel slip is initiated by increasing the transmission drive output rotational speed. For example, the target value of the loading can also be specified as a range of values, for example a value range from 95% to 99%. Depending on the vehicle's settings, however, any other value range can be defined.

Any increase or reduction of the drive output rotational speed of the transmission to reduce or increase the wheel slip is followed by a check to see whether the changes sought lead to acceptable slip values. For this, a lower and an upper threshold value for the slip can be specified, which delimit a physically justified, reasonable slip value range, or one defined by the operator. For example, this can be in a range from 5% to 30%, but a larger or a smaller value range is also conceivable. When adapting the drive output rotational speed of the transmission, falling below or exceeding those threshold values should be avoided, in particular by adapting the increase or reduction of the drive output rotational speed of the transmission. By virtue of the limitations mentioned earlier, stopping of the working machine and/or an unacceptably high power loss due to excessive slip at the wheels is avoided in extreme operating conditions.

If the actual value of the drive-train loading corresponds to the target drive-train loading value, the slip at the wheels is reduced continuously by reducing the drive output rotational speed of the transmission. The result of this is that the target drive-train loading is achieved with the least possible slip.

The previously described adaptation of the drive output rotational speed of the transmission in the event that the maximum value of the drive-train loading is exceeded or if the deviation of the actual value of the drive-train loading from the target value of the drive-train loading is unacceptable, can differ in the dynamic and/or rotational speed step width from the continuous adaptation of the drive output rotational speed of the transmission for bringing about the desired drive-train loading with the least possible slip. In particular, the dynamic and/or rotational speed step width of the adaptation can be the smaller, the smaller is a deviation between the actual and target values.

If the second function id activated, there first takes place a determination of a characteristic value (K) which describes the current (actual) operating condition of the working machine at the beginning of the second function. The characteristic value is obtained from an actual value of the torque (M) at the drive output of the transmission and an actual value of a slip (S) at the wheels, in accordance with the following formula:

K=M·(1−S)

The characteristic value can also be calculated otherwise, for example with a higher weighting of the slip compared with the torque at the drive output of the transmission. In that way, for example, for soil protection purposes better account can be taken of a traction operation of the working machine. A corresponding parameterization can be carried out or preselected either by an operator or, however, also by way of an external interface. The transmission efficiency between the wheel and the roadway increases with maximization of the characteristic value. Conversely, this means that a larger torque at the drive output of the transmission (which behaves proportionally to a drive torque at the driven wheels) goes together with minimized wheel slip.

Thereafter, the drive output rotational speed of the transmission is increased. This is followed by the calculation of a temporary characteristic value (K*), taking account of the increase of the drive output rotational speed of the transmission, wherein this increase is produced as described earlier. Here, the formula for calculating K* corresponds to the formula for calculating K:

K*=M*·(1−S*)

The temporary characteristic value takes account of the current torque applied (M*) and the current wheel slip (S*).

If the increase of the drive output rotational speed of the transmission resulted in a higher value of the characteristic value (K*>K), the temporary characteristic value (K*) replaces the characteristic value (K) as the guide magnitude. This is followed by repeating the increase of the drive output rotational speed and a comparison between the replaced characteristic value and an again calculated new temporary characteristic value (K*). In other words, the sequence in the form of a loop is repeated until the temporary characteristic value is smaller than or equal to the previous characteristic value, i.e. no further increase of the characteristic value is achieved.

A branch is then made into a second loop and thus a check is made to determine whether an increase in the opposite search direction has become possible. The drive output rotational speed of the transmission is reduced accordingly, a temporary characteristic value is calculated and, as before, the temporary characteristic value is compared with the (previous) characteristic value and the drive output rotational speed of the transmission is reduced again until the temporary characteristic value is no longer increased.

When an operating condition is reached in which the characteristic value is maximized, it is checked continually whether an increase or reduction of the drive output rotational speed of the transmission results in a further increase of the characteristic value. To put it otherwise, the steps of the second function described are carried out repeatedly.

In a possible further development, the working machine comprises a measurement system for the direct and/or indirect detection of the torque at the driven wheels or the drive output of the transmission. For a direct measurement, corresponding torque sensors are provided on the driven wheels. In an indirect detection, the proportional drive output rotational speed of the transmission in a hydrostatic/mechanical power-branched continuously variable transmission with a hydrostatic variator is determined by evaluating an oil pressure in the working circuit of the variator.

In a further design a target value for the characteristic is specified, which is associated with an optimum operating point with an expected maximum possible transmission efficiency between the wheel and the roadway. Consequently, by virtue of the second function a maximization of the characteristic value and as a result an optimization of the transmission efficiency are forced.

Furthermore, a threshold value fora minimum driving speed of the working machine when carrying out the method can be taken into account. This input magnitude can also be used to implement the first function, even when the second function has previously been set. This could be advantageous if the speed reaches or falls below the threshold for the minimum driving speed. In that way stopping of the working machine, for example even due to an operational error, can be counteracted. This can also be important if in the second function it is determined that with the currently set parameters the speed will fall below the minimum threshold.

In the same way, in a further development it can be provided that a signal to reduce a traction force demand is emitted if, when implementing both the first and the second function, the driving speed has fallen below the threshold value for the minimum driving speed or cannot be reached. A reduction of the traction force demand can for example be carried out in such manner that a sinking depth of an attachment is reduced.

Furthermore, in a further development a weighting in favor of the first or second function can be entered. Correspondingly, one of the two functions is assigned a higher priority in relation to its implementation. In other words, the function concerned is carried out preferentially, with greater priority. The weighting can be entered by the operator by means of an input device or already programmed in by the manufacturer when the working machine is made or delivered.

According to a further aspect of the present invention a working machine is also included, which comprises a drive unit, a transmission and a control unit. By way of a drive input shaft a drive power is introduced into the transmission, and by way of a drive output shaft the resulting drive output power is transmitted to the wheels of a first and/or a second vehicle axle. In this case the control unit of the working machine is suitable and designed for carrying out the method according to the invention.

### BRIEF DESCRIPTION OF THE DRAWINGS

The invention will be explained with reference to the following figures, which show:

FIG. 1: A schematic representation of a working machine with an attachment;

FIG. 2a: In a schematic representation, a flow chart of the first function of the method for traction-related control of a drive-train of a working machine;

FIG. 2b: In a schematic representation, a flow chart of the second function of the method for traction-related control of a drive-train of a working machine.

### DETAILED DESCRIPTION OF THE PREFERRED EMBODIMENTS

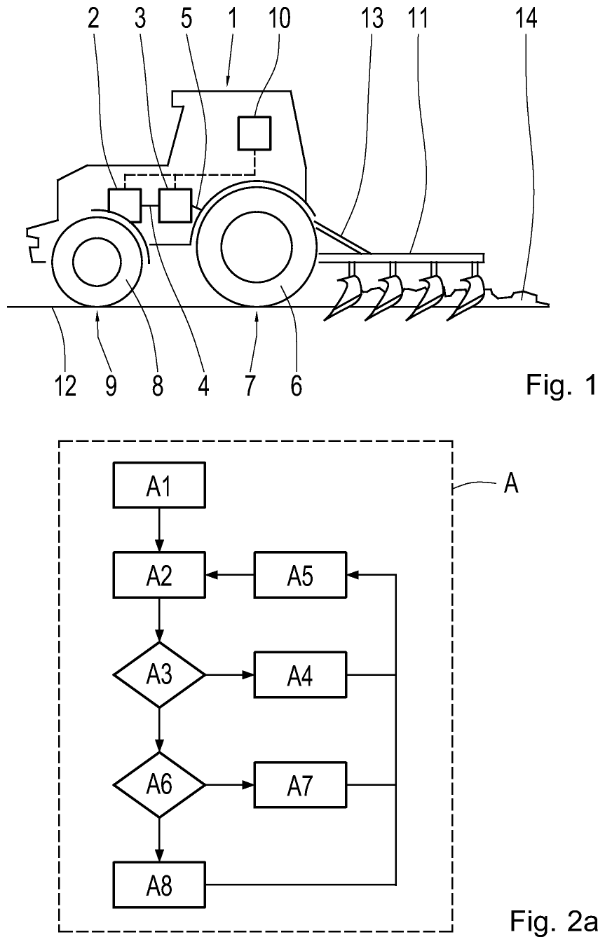

FIG. 1 shows in greatly simplified schematic form a working machine 1 with an attachment 11. The working machine 1 in this case is in the form of a tractor or farming tractor and has a drive unit 2, a transmission 3 and a control unit 10. The drive unit is connected by a driveshaft 4 to an input of the transmission 3, while an output of the transmission 3 is connected by way of a drive output shaft 5 to a first vehicle axle 7 or the wheels 6 fitted on it. The drive unit 2 supplies a drive power, which is passed by way of the driveshaft 4 into the transmission 3 and, in accordance with the gear ratio set, is transmitted by way of the drive output shaft 5 to the first vehicle axle 7. In this case the working machine 1 has a second vehicle axle 9, on which wheels 8 are fitted. The second vehicle axle 9 can likewise be connected to the drive output shaft 5 or to the first vehicle axle 7, and correspondingly all the wheels 6, 8 of the working machine 1 will then be driven wheels.

The control unit 10 is connected to transmit signals to the transmission 3 and/or the drive unit 2, as illustrated by the broken lines. Moreover, the control unit 10 comprises a sensor or measuring device (not shown) for detecting a driving speed of the working machine 1. Instead of being integrated in the control unit 10, the sensor can also be a separate component with a signal-transmitting connection.

In this case the attachment 11 is in the form of a plow. In alternative embodiments it can also be any other agricultural attachment for working the soil or for harvesting crops. In the simplest version it can also be a trailer. By means of a lifting device 13, the height of the attachment 11, in particular the plow, can be adjusted. Depending on the lifting height of the attachment 11 set, a sinking depth into the ground 12 changes. In particular, the ground 12 is a surface of an agriculturally useful area. In alternative versions, however, the ground 12 can also be a path or a road and in such cases usually attachments 11 other than the plow of the present example are connected to the working machine 1. By embedding the attachment 11 in the ground 12, the latter is broken up or raised, as illustrated by a raised area 14.

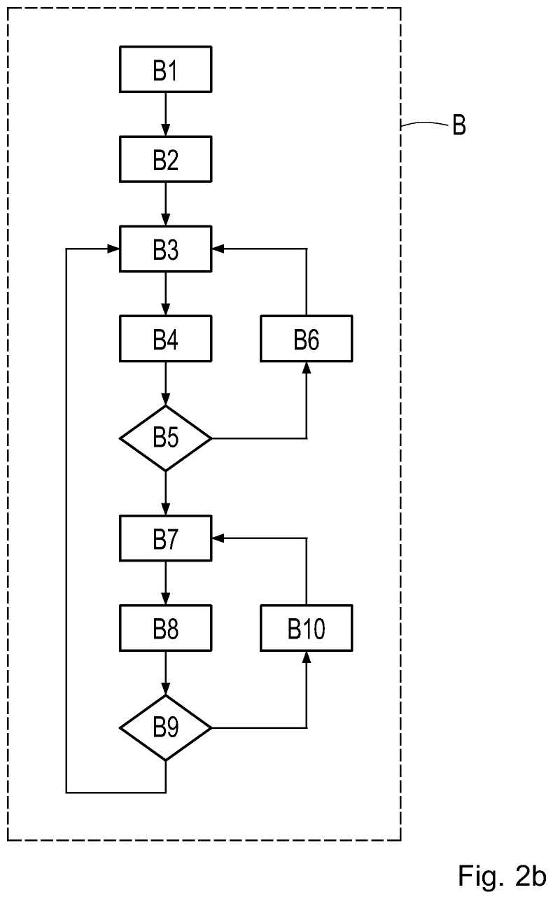

In FIG. 2a, in a schematic representation a flow chart of a first function A for the traction-related control of a drive-train of a working machine 1 is shown. Here, in a first process step A1 the first function A according to the invention is activated. In a second process step A2, an actual value of the loading of the drive-train and an actual value of the slip at the wheels 6, 8 are determined.

In a third process step A3, the actual value of the loading of the drive-train is compared with a maximum value of the loading of the drive-train. As long as the actual loading value is greater than or equal to the maximum value concerned, in a fourth process step A4 the slip at the wheels 6, 8 is reduced. This is done either by changing the gear ratio of the transmission 3 and/or by reducing the rotational speed of the drive unit 2, but in both cases the drive output rotational speed of the transmission 3 is reduced. In a fifth process step A5 a specification for reducing the value of the slip at the wheels 6, 8 is triggered. This should be understood to mean that the reduction in the fifth process step A5 is specified dynamically as a constant value, for example as a percentage fraction of the deviation or of the loading, or as a function of further factors (such as the driving speed, the gear ratio set in the transmission 3, etc.) with reference to a characteristic diagram or an algorithm. In addition, a comparison is carried out to see whether with the change, an acceptable slip value is reached, the slip is consequently not below a lower threshold value, and an upper threshold value for the slip is not exceeded.

The sequence of the second, third, fourth and fifth process steps A2, A3, A4, A5 is repeated in a loop until in the third process step A3 the actual value of the loading is smaller than the maximum value concerned. This is followed by a sixth process step A6 in which a comparison of the actual loading value with a target value of the loading takes place. So long as the actual loading value does not correspond to a target loading value, in a seventh process step A7 the slip at the wheels 6, 8 is increased. This is done by increasing the drive output rotational speed of the transmission 3. The process then reverts to the fifth process step A5 and a new run from the second process step A2 takes place. The target value of the loading can in the process be specified as an exact value or a defined value range.

If in the sixth process step A6 it is found that the actual value of the drive-train loading matches the target value of the drive-train loading, then in an eighth process step A8 the actual value of the slip at the wheels 6, 8 is reduced by reducing the drive output rotational speed of the transmission 3. After passing through the fifth process step A5, the function A according to the invention begins afresh with the second process step A2. In other words by virtue of the first function A, a permanent traction-related or slip-related loading regulation of the working machine 1 or its drive-train takes place. By virtue of the continuous repetition through process steps A1 to A8 in the above-described sequence, it is possible in a simple manner to react to changing environmental conditions, in particular changing traction resistances due to different surface conditions of the ground 12.

In a manner similar to FIG. 2a above, FIG. 2b shows a schematic representation of a flow chart, but in this case that of a second function B for the traction-related control of a drive-train of a working machine 1. In a first process step B1, the second function B according to the invention is activated. In a second process step B2, a characteristic value is determined, which characterizes an operating condition of the working machine 1 or its drive-train at the beginning of the second function B. In a third process step B3 the drive output rotational speed of the transmission 3 is increased, after which in a fourth process step B4 the characteristic value is recalculated. That characteristic is taken as a temporary characteristic value.

In a fifth process step B5 the temporary characteristic value is compared with the characteristic value determined in the second process step B2. So long as the temporary characteristic is larger than the characteristic calculated in the second process step B2, in a sixth process step B6 the temporary characteristic replaces the characteristic calculated in the second process step B2 and the system reverts to the third process step B3. The process steps B3 to B6 are repeated cyclically until it is found in the fifth process step B5 that the temporary characteristic is smaller than or identical to the characteristic value calculated in the second or the sixth process step B2, B6.

When that is the case, in a seventh process step B7 the drive output rotational speed of the transmission 3 is reduced. Analogously to the increase of the drive output rotational speed of the transmission 3 in the third process step B3, this is done by adapting the rotational speed/torque of the drive unit 2 and/or by adapting the gear ratio of the transmission 3. Then, in an eighth process step B8 a temporary characteristic value is again determined. In a ninth process step B9 the temporary characteristic is again compared with the characteristic from the fifth process step B5. If the temporary characteristic is larger than the characteristic from the fifth process step B5, then in a tenth process step B10 the temporary characteristic replaces the characteristic from the fifth process step B5 and the system reverts to the seventh process step B7 as the input magnitude.

The process steps B7 to B10 are repeated cyclically until it is found in the ninth process step B9 that the temporary characteristic is smaller than or identical to the characteristic from the fifth process step B5. Only then does the system revert to the third process step B3 and the function sequence begins afresh from there in the previously described sequence of process steps B3 to B10.

The control unit 10 shown in FIG. 1 is suitable and designed to carry out the first and/or the second function A, B for the traction-related control of the drive-train of the working machine 1. For that purpose an input device (not shown) can be provided, by means of which an operator chooses whether to carry out the first or second function A, B. Furthermore, in a further design the control unit 10 can alternatively or additionally be suitable and designed to change between the first and second functions A, B for the optimum operation of the working machine 1. This can also include the approval of a choice of the operator's to implement the first or second functions A, B. Likewise, it can be provided that a choice by the operator is in agreement with a choice by the control unit 10.

### INDEXES

1 Working machine
2 Drive unit
3 Transmission
4 Driveshaft
5 Drive output shaft
6 Wheel
7 First vehicle axle
8 Wheel
9 Second vehicle axle
10 Control unit
11 Attachment
12 Roadway
13 Lifting device
14 Raised area
A First function
A1-A8 Process steps of the first function
B Second function
B1-B10 Process steps of the second function

1-10. (canceled)

11. A method for traction-related control of a drive-train of a working machine (1) having a drive unit (2), a transmission (3), a control unit (10) and first and second vehicle axles (7, 9) with wheels (6, 8), the method comprising:
driving at least one of the vehicle axles (7, 9),
implementing either a first function (A) or a second function (B) as a function of a specification, and
implementing a slip-orientated loading control with the first function (A) and implementing a traction-efficiency control of the drive-train of the working machine (1) with the second function (B).

12. The method according to claim 11, further comprising after activating the first function (A):
first determining an actual value of loading of the drive-train and an actual value of slip at the wheels (6, 8);
reducing the actual value of the slip at the wheels (6, 8) by reducing drive output rotational speed of the transmission (3) until the actual value of the loading of the drive-train falls below a maximum value of the drive-train loading;
then comparing the actual value of the drive-train loading with a target value of the drive-train loading, and initiating an increase of the slip at the wheels (6, 8) if the actual value of the drive-train loading differs from the target value of the drive-train loading;
reducing slip at the wheels (6, 8) when the actual value of the drive-train loading corresponds to the target value of the drive-train loading; and
following each increase or decrease of the drive output rotational speed of the transmission (3) with a check to confirm acceptable slip values.

13. The method according to claim 11, further comprising after activating the second function (B):
first determining a characteristic value for characterizing an operating condition of the working machine (1);
increasing a drive output rotational speed of the transmission (3), then determining a temporary characteristic value for characterizing an operating condition of the working machine (1);
comparing the characteristic value and the temporary characteristic value and replacing the characteristic value with the temporary characteristic value if the temporary characteristic value is larger than the characteristic value, after which increasing the drive output rotational speed of the transmission (3), and again comparing the characteristic values, until the temporary characteristic value is smaller than or equal to the characteristic value;
then reducing the drive output rotational speed of the transmission (3) and repeating the determination of a temporary characteristic value;
thereafter comparing the characteristic value with the temporary characteristic value and replacing the characteristic value with the temporary characteristic value if the temporary characteristic value is larger than the characteristic value, after which the drive output rotational speed of the transmission (3) is reduced again and the characteristic values are compared again until the temporary characteristic value is smaller than or equal to the characteristic value; and
the system then reverts to the increase of the drive output rotational speed of the transmission (3) and the previous steps are repeated.

14. The method according to claim 13, further comprising specifying a weighting for the calculation of the characteristic value by at least one of an operator and an external interface.

15. The method according to claim 11, wherein the specification to implement at least one of the first and the second function (A, B) takes place by way of an input by an operator.

16. The method according to claim 11, wherein the specification to implement at least one of the first and the second function (A, B) takes place in accordance with preferences stored in the control unit (10).

17. The method according to claim 11, further comprising, carrying out the first function (A) independently of a previously set specification, if, when the second function (B) is implemented, a minimum driving speed falls below or cannot exceed a threshold value.

18. The method according to claim 11, further comprising emitting a signal to reduce a traction force demand if, when implementing the first function (A) and the second function (B), the driving speed falls below a minimum threshold value.

19. The method according to any claim 11, further comprising enabling a weighting in favor of one of the first and the second functions (A, B) to be entered by at least one of an operator and an external interface, so that one of the first and the second functions (A, B) has a higher priority with regard to its implementation.

20. A working machine (1) with a drive unit (2), a transmission (3) and a control unit (10), wherein a drive power is introduced into the transmission (3) by way of a driveshaft (4) and the resulting drive power is transmitted, via a drive output shaft (5), to wheels (6, 8) of at least one of first and second vehicle axles (7, 9), and the control unit (10) being configured to carrying out the method according to the invention in accordance with claim 11.
